(19) United States
(12) Patent Application Publication
(10) Pub. No.: US 2025/0103884 A1
(43) Pub. Date: Mar. 27, 2025

(54) Method, System, and Computer Program Product for Spatial-Temporal Prediction Using Trained Spatial-Temporal Masked Autoencoders

(71) Applicant: Visa International Service Association, San Francisco, CA (US)

(72) Inventors: Yujie Fan, Cleveland Heights, OH (US); Jiarui Sun, Urbana, IL (US); Michael Yeh, Newark, CA (US); Wei Zhang, Fremont, CA (US)

(21) Appl. No.: 18/889,563

(22) Filed: Sep. 19, 2024

Related U.S. Application Data
(60) Provisional application No. 63/584,347, filed on Sep. 21, 2023.

(51) Int. Cl. G06N 3/08; G06N 3/0455

(52) U.S. Cl. CPC G06N 3/08; G06N 3/0455

(57) ABSTRACT

Methods, systems, and computer program products are provided for spatial-temporal prediction using trained spatial-temporal masked autoencoders. An example system includes a processor configured to determine a structural dependency graph associated with a networked system. The processor is also configured to receive multivariate time-series data from a first time period associated with the networked system. The processor is further configured to mask the plurality of edges of the structural dependency graph and mask the multivariate time-series data. The processor is further configured to train a spatial-temporal autoencoder based on the masked structural representation and the masked temporal representation. The processor is further configured to generate a prediction using a spatial-temporal machine learning model including the trained spatial-temporal autoencoder, the prediction associated with an attribute of the networked system in a second time period subsequent to the first time period.

### CROSS REFERENCE TO RELATED APPLICATION

This application claims priority to U.S. Provisional Patent Application No. 63/584,347, filed Sep. 21, 2023, the disclosure of which is hereby incorporated by reference in its entirety.

### BACKGROUND

### 1. Technical Field

This disclosure relates generally to spatial-temporal forecasting, and, in non-limiting embodiments or aspects, to systems, methods, and computer program products for spatial-temporal prediction using trained spatial-temporal masked autoencoders.

### 2. Technical Considerations

Spatial-temporal prediction is useful for numerous systems, including traffic forecasting, weather forecasting, network activity prediction, and skeleton-based human action recognition, among others. In each of those applications, a prediction may be made about a future time and place based on data of historic times and places. However, to make such predictions, it may be necessary to explicitly model spatial dependencies and temporal correlations among time-series variables, which leads to high model complexity and the use of excessive computer resources (e.g., memory, bandwidth, processing capacity, etc.) for model preprocessing, training, and execution. Moreover, known solutions suffer from data scarcity and overfitting issues.

There is a need in the art for a technical solution for learning spatial-temporal information from networked systems to more accurately predict future multivariate time-series data, while minimizing computer resources required to achieve such levels of prediction accuracy.

### SUMMARY

Accordingly, provided are improved systems, methods, and computer program products for spatial-temporal prediction using trained spatial-temporal masked autoencoders.

According to some non-limiting embodiments or aspects, provided is a computer-implemented method for spatial-temporal prediction using trained spatial-temporal masked autoencoders. The method includes determining, with at least one processor, a structural dependency graph associated with a networked system, the structural dependency graph including a plurality of vertices connected by a plurality of edges. The method also includes receiving, with at least one processor, multivariate time-series data from a first time period associated with the networked system. The method further includes masking, with at least one processor, the plurality of edges of the structural dependency graph to produce a masked structural representation of the structural dependency graph. The method further includes masking, with at least one processor, the multivariate time-series data to produce a masked temporal representation of the multivariate time-series data. The method further includes training, with at least one processor, a spatial-temporal autoencoder based on the masked structural representation and the masked temporal representation to produce a trained spatial-temporal autoencoder. Training the spatial-temporal autoencoder includes generating a first loss parameter based on a first decoder reconstruction of the structural dependency graph from the masked structural representation. Training the spatial-temporal autoencoder also includes generating a second loss parameter based on a second decoder reconstruction of the multivariate time-series data from the masked temporal representation. Training the spatial-temporal autoencoder further includes minimizing a loss function including a combination of the first loss parameter and the second loss parameter. The method further includes generating, with at least one processor, a prediction using a spatial-temporal machine learning model including the trained spatial-temporal autoencoder, the prediction associated with an attribute of the networked system in a second time period subsequent to the first time period.

In some non-limiting embodiments or aspects, the networked system may include a road system of interconnected roads, the plurality of edges may be associated with a plurality of roads, and the plurality of vertices may be associated with a plurality of intersections.

In some non-limiting embodiments or aspects, the prediction may include a forecast of traffic in the road system, and the method further may include transmitting, with at least one processor, the prediction to a computing device of a user. The computing device and the user may be traveling on a road of the road system when the prediction is transmitted to the computing device.

In some non-limiting embodiments or aspects, the networked system may include a computer network of interconnected computing devices, the plurality of vertices may be associated with a plurality of computing devices, and the plurality of edges may be associated with communicative connections between computing devices of the plurality of computing devices.

In some non-limiting embodiments or aspects, the prediction may include a forecast of network activity in the computer network, and the method may further include transmitting, with at least one processor, a notification to a computing device of a user based on the prediction.

In some non-limiting embodiments or aspects, masking the plurality of edges of the structural dependency graph may include masking the plurality of edges of the structural dependency graph using a biased random walk process. Masking the multivariate time-series data may include masking the multivariate time-series data using a subsequence patchwise masking process.

In some non-limiting embodiments or aspects, the first loss parameter may include a classification loss based on the first decoder reconstruction of the structural dependency graph from the masked structural representation. The second loss parameter may include a regression loss based on the second decoder reconstruction of the multivariate time-series data from the masked temporal representation.

According to some non-limiting embodiments or aspects, provided is a system for spatial-temporal prediction using trained spatial-temporal masked autoencoders. The system includes at least one processor. The at least one processor is configured to determine a structural dependency graph associated with a networked system, the structural dependency graph including a plurality of vertices connected by a plurality of edges. The at least one processor is also configured to receive multivariate time-series data from a first time period associated with the networked system. The at least one processor is further configured to mask the plurality of edges of the structural dependency graph to produce a masked structural representation of the structural dependency graph. The at least one processor is further configured to mask the multivariate time-series data to produce a masked temporal representation of the multivariate time-series data. The at least one processor is further configured to train a spatial-temporal autoencoder based on the masked structural representation and the masked temporal representation to produce a trained spatial-temporal autoencoder. When training the spatial-temporal autoencoder, the at least one processor is configured to generate a first loss parameter based on a first decoder reconstruction of the structural dependency graph from the masked structural representation. When training the spatial-temporal autoencoder, the at least one processor is also configured to generate a second loss parameter based on a second decoder reconstruction of the multivariate time-series data from the masked temporal representation. When training the spatial-temporal autoencoder, the at least one processor is further configured to minimize a loss function including a combination of the first loss parameter and the second loss parameter. The at least one processor is further configured to generate a prediction using a spatial-temporal machine learning model including the trained spatial-temporal autoencoder, the prediction associated with an attribute of the networked system in a second time period subsequent to the first time period.

In some non-limiting embodiments or aspects, the networked system may include a road system of interconnected roads, the plurality of edges may be associated with a plurality of roads, and the plurality of vertices may be associated with a plurality of intersections.

In some non-limiting embodiments or aspects, the prediction may include a forecast of traffic in the road system, and the at least one processor may be further configured to transmit the prediction to a computing device of a user. The computing device and the user may be traveling on a road of the road system when the prediction is transmitted to the computing device.

In some non-limiting embodiments or aspects, the networked system may include a computer network of interconnected computing devices, the plurality of vertices may be associated with a plurality of computing devices, and the plurality of edges may be associated with communicative connections between computing devices of the plurality of computing devices.

In some non-limiting embodiments or aspects, the prediction may include a forecast of network activity in the computer network, and the at least one processor may be further configured to transmit a notification to a computing device of a user based on the prediction.

In some non-limiting embodiments or aspects, when masking the plurality of edges of the structural dependency graph, the at least one processor may be configured to mask the plurality of edges of the structural dependency graph using a biased random walk process. When masking the multivariate time-series data, the at least one processor may be configured to mask the multivariate time-series data using a subsequence patchwise masking process.

In some non-limiting embodiments or aspects, the first loss parameter may include a classification loss based on the first decoder reconstruction of the structural dependency graph from the masked structural representation. The second loss parameter may include a regression loss based on the second decoder reconstruction of the multivariate time-series data from the masked temporal representation.

According to some non-limiting embodiments or aspects, provided is a computer program product for spatial-temporal prediction using trained spatial-temporal masked autoencoders. The computer program product includes at least one non-transitory computer-readable medium including program instructions that, when executed by at least one processor, cause the at least one processor to determine a structural dependency graph associated with a networked system, the structural dependency graph including a plurality of vertices connected by a plurality of edges. The program instructions also cause the at least one processor to receive multivariate time-series data from a first time period associated with the networked system. The program instructions further cause the at least one processor to mask the plurality of edges of the structural dependency graph to produce a masked structural representation of the structural dependency graph. The program instructions further cause the at least one processor to mask the multivariate time-series data to produce a masked temporal representation of the multivariate time-series data. The program instructions further cause the at least one processor to train a spatial-temporal autoencoder based on the masked structural representation and the masked temporal representation to produce a trained spatial-temporal autoencoder. The program instructions that cause the at least one processor to train the spatial-temporal autoencoder cause the at least one processor to generate a first loss parameter based on a first decoder reconstruction of the structural dependency graph from the masked structural representation. The program instructions that cause the at least one processor to train the spatial-temporal autoencoder also cause the at least one processor to generate a second loss parameter based on a second decoder reconstruction of the multivariate time-series data from the masked temporal representation. The program instructions that cause the at least one processor to train the spatial-temporal autoencoder further cause the at least one processor to minimize a loss function including a combination of the first loss parameter and the second loss parameter. The program instructions further cause the at least one processor to generate a prediction using a spatial-temporal machine learning model including the trained spatial-temporal autoencoder, the prediction associated with an attribute of the networked system in a second time period subsequent to the first time period.

In some non-limiting embodiments or aspects, the networked system may include a road system of interconnected roads, the plurality of edges may be associated with a plurality of roads, and the plurality of vertices may be associated with a plurality of intersections.

In some non-limiting embodiments or aspects, the prediction may include a forecast of traffic in the road system, and the program instructions may further cause the at least one processor to transmit the prediction to a computing device of a user. The computing device and the user may be traveling on a road of the road system when the prediction is transmitted to the computing device.

In some non-limiting embodiments or aspects, the networked system may include a computer network of interconnected computing devices, the plurality of vertices may be associated with a plurality of computing devices, and the plurality of edges may be associated with communicative connections between computing devices of the plurality of computing devices. The prediction may include a forecast of network activity in the computer network, and the program instructions may further cause the at least one processor to transmit a notification to a computing device of a user based on the prediction.

In some non-limiting embodiments or aspects, the program instructions that cause the at least one processor to mask the plurality of edges of the structural dependency graph may cause the at least one processor to mask the plurality of edges of the structural dependency graph using a biased random walk process. The program instructions that cause the at least one processor to mask the multivariate time-series data may cause the at least one processor to mask the multivariate time-series data using a subsequence patchwise masking process.

In some non-limiting embodiments or aspects, the first loss parameter may include a classification loss based on the first decoder reconstruction of the structural dependency graph from the masked structural representation. The second loss parameter may include a regression loss based on the second decoder reconstruction of the multivariate time-series data from the masked temporal representation.

Further non-limiting embodiments or aspects are set forth in the following numbered clauses:

Clause 1: A computer-implemented method comprising: determining, with at least one processor, a structural dependency graph associated with a networked system, the structural dependency graph comprising a plurality of vertices connected by a plurality of edges; receiving, with at least one processor, multivariate time-series data from a first time period associated with the networked system; masking, with at least one processor, the plurality of edges of the structural dependency graph to produce a masked structural representation of the structural dependency graph; masking, with at least one processor, the multivariate time-series data to produce a masked temporal representation of the multivariate time-series data; training, with at least one processor, a spatial-temporal autoencoder based on the masked structural representation and the masked temporal representation to produce a trained spatial-temporal autoencoder, wherein training the spatial-temporal autoencoder comprises: generating a first loss parameter based on a first decoder reconstruction of the structural dependency graph from the masked structural representation; generating a second loss parameter based on a second decoder reconstruction of the multivariate time-series data from the masked temporal representation; and minimizing a loss function comprising a combination of the first loss parameter and the second loss parameter; and generating, with at least one processor, a prediction using a spatial-temporal machine learning model comprising the trained spatial-temporal autoencoder, the prediction associated with an attribute of the networked system in a second time period subsequent to the first time period.

Clause 2: The method of clause 1, wherein the networked system comprises a road system of interconnected roads, wherein the plurality of edges is associated with a plurality of roads, and wherein the plurality of vertices is associated with a plurality of intersections.

Clause 3: The method of clause 1 or clause 2, wherein the prediction comprises a forecast of traffic in the road system, and wherein the method further comprises transmitting, with at least one processor, the prediction to a computing device of a user, the computing device and the user traveling on a road of the road system when the prediction is transmitted to the computing device.

Clause 4: The method of any of clauses 1-3, wherein the networked system comprises a computer network of interconnected computing devices, wherein the plurality of vertices is associated with a plurality of computing devices, and wherein the plurality of edges is associated with communicative connections between computing devices of the plurality of computing devices.

Clause 5: The method of any of clauses 1-4, wherein the prediction comprises a forecast of network activity in the computer network, and wherein the method further comprises transmitting, with at least one processor, a notification to a computing device of a user based on the prediction.

Clause 6: The method of any of clauses 1-5, wherein masking the plurality of edges of the structural dependency graph comprises masking the plurality of edges of the structural dependency graph using a biased random walk process, and wherein masking the multivariate time-series data comprises masking the multivariate time-series data using a subsequence patchwise masking process.

Clause 7: The method of any of clauses 1-6, wherein the first loss parameter comprises a classification loss based on the first decoder reconstruction of the structural dependency graph from the masked structural representation, and wherein the second loss parameter comprises a regression loss based on the second decoder reconstruction of the multivariate time-series data from the masked temporal representation.

Clause 8: A system comprising: at least one processor configured to: determine a structural dependency graph associated with a networked system, the structural dependency graph comprising a plurality of vertices connected by a plurality of edges; receive multivariate time-series data from a first time period associated with the networked system; mask the plurality of edges of the structural dependency graph to produce a masked structural representation of the structural dependency graph; mask the multivariate time-series data to produce a masked temporal representation of the multivariate time-series data; train a spatial-temporal autoencoder based on the masked structural representation and the masked temporal representation to produce a trained spatial-temporal autoencoder, wherein, when training the spatial-temporal autoencoder, the at least one processor is configured to: generate a first loss parameter based on a first decoder reconstruction of the structural dependency graph from the masked structural representation; generate a second loss parameter based on a second decoder reconstruction of the multivariate time-series data from the masked temporal representation; and minimize a loss function comprising a combination of the first loss parameter and the second loss parameter; and generate a prediction using a spatial-temporal machine learning model comprising the trained spatial-temporal autoencoder, the prediction associated with an attribute of the networked system in a second time period subsequent to the first time period.

Clause 9: The system of clause 8, wherein the networked system comprises a road system of interconnected roads, wherein the plurality of edges is associated with a plurality of roads, and wherein the plurality of vertices is associated with a plurality of intersections.

Clause 10: The system of clause 8 or clause 9, wherein the prediction comprises a forecast of traffic in the road system, and wherein the at least one processor is further configured to transmit the prediction to a computing device of a user, the computing device and the user traveling on a road of the road system when the prediction is transmitted to the computing device.

Clause 11: The system of any of clauses 8-10, wherein the networked system comprises a computer network of interconnected computing devices, wherein the plurality of vertices is associated with a plurality of computing devices, and wherein the plurality of edges is associated with communicative connections between computing devices of the plurality of computing devices.

Clause 12: The system of any of clauses 8-11, wherein the prediction comprises a forecast of network activity in the computer network, and wherein the at least one processor is further configured to transmit a notification to a computing device of a user based on the prediction.

Clause 13: The system of any of clauses 8-12, wherein, when masking the plurality of edges of the structural dependency graph, the at least one processor is configured to mask the plurality of edges of the structural dependency graph using a biased random walk process, and wherein, when masking the multivariate time-series data, the at least one processor is configured to mask the multivariate time-series data using a subsequence patchwise masking process.

Clause 14: The system of any of clauses 8-13, wherein the first loss parameter comprises a classification loss based on the first decoder reconstruction of the structural dependency graph from the masked structural representation, and wherein the second loss parameter comprises a regression loss based on the second decoder reconstruction of the multivariate time-series data from the masked temporal representation.

Clause 15: A computer program product comprising at least one non-transitory computer-readable medium including program instructions that, when executed by at least one processor, cause the at least one processor to: determine a structural dependency graph associated with a networked system, the structural dependency graph comprising a plurality of vertices connected by a plurality of edges; receive multivariate time-series data from a first time period associated with the networked system; mask the plurality of edges of the structural dependency graph to produce a masked structural representation of the structural dependency graph; mask the multivariate time-series data to produce a masked temporal representation of the multivariate time-series data; train a spatial-temporal autoencoder based on the masked structural representation and the masked temporal representation to produce a trained spatial-temporal autoencoder, wherein the program instructions that cause the at least one processor to train the spatial-temporal autoencoder cause the at least one processor to: generate a first loss parameter based on a first decoder reconstruction of the structural dependency graph from the masked structural representation; generate a second loss parameter based on a second decoder reconstruction of the multivariate time-series data from the masked temporal representation; and minimize a loss function comprising a combination of the first loss parameter and the second loss parameter; and generate a prediction using a spatial-temporal machine learning model comprising the trained spatial-temporal autoencoder, the prediction associated with an attribute of the networked system in a second time period subsequent to the first time period.

Clause 16: The computer program product of clause 15, wherein the networked system comprises a road system of interconnected roads, wherein the plurality of edges is associated with a plurality of roads, and wherein the plurality of vertices is associated with a plurality of intersections.

Clause 17: The computer program product of clause 15 or clause 16, wherein the prediction comprises a forecast of traffic in the road system, and wherein the program instructions further cause the at least one processor to transmit the prediction to a computing device of a user, the computing device and the user traveling on a road of the road system when the prediction is transmitted to the computing device.

Clause 18: The computer program product of any of clauses 15-17, wherein the networked system comprises a computer network of interconnected computing devices, wherein the plurality of vertices is associated with a plurality of computing devices, wherein the plurality of edges is associated with communicative connections between computing devices of the plurality of computing devices, wherein the prediction comprises a forecast of network activity in the computer network, and wherein the program instructions further cause the at least one processor to transmit a notification to a computing device of a user based on the prediction.

Clause 19: The computer program product of any of clauses 15-18, wherein the program instructions that cause the at least one processor to mask the plurality of edges of the structural dependency graph cause the at least one processor to mask the plurality of edges of the structural dependency graph using a biased random walk process, and wherein the program instructions that cause the at least one processor to mask the multivariate time-series data cause the at least one processor to mask the multivariate time-series data using a subsequence patchwise masking process.

Clause 20: The computer program product of any of clauses 15-19, wherein the first loss parameter comprises a classification loss based on the first decoder reconstruction of the structural dependency graph from the masked structural representation, and wherein the second loss parameter comprises a regression loss based on the second decoder reconstruction of the multivariate time-series data from the masked temporal representation.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for spatial-temporal prediction using trained spatial-temporal masked autoencoders, according to some non-limiting embodiments or aspects;

FIG. 2 is a schematic diagram of example components of one or more devices of FIG. 1, according to some non-limiting embodiments or aspects;

FIG. 3 is a flow diagram of a method for spatial-temporal prediction using trained spatial-temporal masked autoencoders, according to some non-limiting embodiments or aspects;

FIG. 4 is a schematic diagram of a method for spatial-temporal prediction using spatial-temporal masked autoencoders, according to some non-limiting embodiments or aspects;

FIG. 5 is a schematic diagram of a method for spatial-temporal prediction using spatial-temporal masked autoencoders, according to some non-limiting embodiments or aspects;

FIG. 6 is a schematic diagram of a method for spatial-temporal prediction using spatial-temporal masked autoencoders, according to some non-limiting embodiments or aspects;

FIG. 7 is a schematic diagram of a method for spatial-temporal prediction using spatial-temporal masked autoencoders, according to some non-limiting embodiments or aspects; and

FIG. 8 is a schematic diagram of a method for spatial-temporal prediction using spatial-temporal masked autoencoders, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally, or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, one or more computing devices used by a payment device provider system, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

The methods, systems, and computer program products described herein provide numerous technical advantages in systems for spatial-temporal forecasting. First, in comparison to existing solutions, the disclosed solution herein reduces model complexity by not requiring explicit modeling of spatial dependencies and temporal correlations among multivariate time-series (MTS) data. Moreover, model performance (e.g., accuracy, as measured by an error metric) is greatly improved, overcoming technical hurdles due to data scarcity, data noise, and overfitting. The disclosed solution requires less computer resources (e.g., memory, bandwidth, processing capacity) to achieve the same level of performance by decoupling and masking the spatial and temporal aspects of a networked system to create a combined spatial-temporal autoencoder. Moreover, separate structural and temporal decoders may be used to train the spatial-temporal autoencoder, improving the accuracy of the prediction model through the use of a combined loss function. More accurate predictive models have direct impacts on the efficiencies of the analyzed networked systems, by reducing false positives (e.g., reducing computing resources mustered in response to incorrect triggers) and reducing false negatives (e.g., reducing computing resources mustered late in response to missed triggers). In some non-limiting embodiments, predictions produced by the modeling systems described herein may be transmitted to computing devices in the networks that are being modeled, to create a positive feedback loop (e.g., for a computing device of a user navigating through vehicular traffic, for a computing device of a user monitoring for anomalous network traffic, etc.).

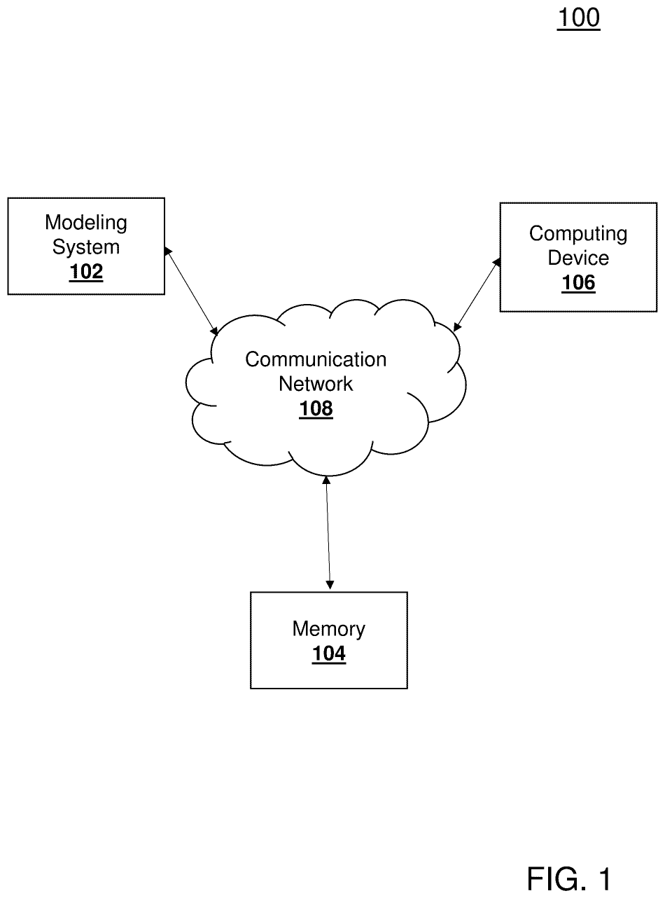

Referring now to FIG. 1, shown is a diagram of an example system 100, according to some non-limiting embodiments or aspects. As shown in FIG. 1, system 100 may include modeling system 102, memory 104, computing device 106, and communication network 108. Modeling system 102, memory 104, and computing device 106 may interconnect (e.g., establish a connection to communicate) via wired connections, wireless connections, or a combination of wired and wireless connections. In some non-limiting embodiments or aspects, system 100 may further include a natural language processing system, a weather forecasting system, a human body motion-mapping system, a pandemic spread prediction system, a vehicular traffic forecasting system, a computer network traffic forecasting system, an advertising system, a fraud detection system, a transaction processing system, a merchant system, an acquirer system, an issuer system, and/or a payment device.

Modeling system 102 may include one or more computing devices configured to communicate with memory 104 and/or computing device 106 at least partly over communication network 108. Modeling system 102 may be configured to receive data to train one or more spatial-temporal machine learning models, may be configured to train one or more spatial-temporal machine learning models, and may be configured to use one or more trained spatial-temporal machine learning models to generate an output. Modeling system 102 may include or be in communication with memory 104. Modeling system 102 may be associated with, or included in a same system as, a system deploying one or more spatial-temporal machine learning models, such as a weather forecasting system, a human body motion-mapping system, a pandemic spread prediction system, a vehicular traffic forecasting system, a computer network traffic forecasting system, and/or the like.

Memory 104 may include one or more computing devices configured to communicate with modeling system 102 and/or computing device 106 at least partly over communication network 108. Memory 104 may be configured to store data associated with a system for which spatial-temporal prediction is to be performed, such as network structure (e.g., vertices connected by edges), MTS data, and/or the like, in one or more non-transitory computer readable storage media. Memory 104 may communicate with and/or be included in modeling system 102.

Computing device 106 may include one or more processors that are configured to communicate with modeling system 102 and/or memory 104 at least partly over communication network 108. Computing device 106 may be associated with a user and may include at least one user interface for transmitting data to and receiving data from modeling system 102 and/or memory 104. For example, computing device 106 may show, on a display of computing device 106, one or more outputs of trained spatial-temporal machine learning models executed by modeling system 102. By way of further example, one or more inputs for trained spatial-temporal machine learning models may be determined or received by modeling system 102 via a user interface of computing device 106.

Additionally, or alternatively, user may receive notifications (e.g., alert messages) from modeling system 102 at computing device 106, which may be positioned with user. For example, for a modeling system 102 configured as a vehicular traffic forecasting system, modeling system 102 may transmit a traffic forecast (e.g., date of traffic density associated with one or more roads and/or intersections) to computing device 106 of a user that is traveling (e.g., positioned in and intended to move within) a road system. By way of further example, for a modeling system 102 configured as a computer network traffic forecasting system, modeling system 102 may transmit a notification (e.g., an alert of anomalous network activity) to computing device 106 of a user (e.g., an internet technology (IT) specialist, a network security specialist, an administrator, etc.), which may further automatically trigger mitigating processes performed at or in association with computing device 106 (e.g., intercepting network packets associated with anomalous activity, deactivating an active communication connection used by a network device that is exhibiting anomalous behavior, and/or the like). In some non-limiting embodiments or aspects, computing device 106 may be a mobile device.

Communication network 108 may include one or more wired and/or wireless networks over which the systems and devices of system 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of system 100 may perform one or more functions described as being performed by another set of systems or another set of devices of system 100.

In some non-limiting embodiments or aspects, modeling system 102 may be configured to carry out one or more processes described herein. For example, modeling system 102 may determine a structural dependency graph associated with a networked system (e.g., a system of geolocations for a weather prediction model, a system of joints for a human body motion-mapping model, a computer network of interconnected computing devices for a network activity prediction model, a road system of interconnected roads for a vehicular traffic prediction model, etc.). The structural dependency graph may include a plurality of vertices (e.g., nodes) connected by a plurality of edges (e.g., node-to-node dependencies). Modeling system 102 may receive MTS data (e.g., records with multiple fields, including at least one time-dependent field) from a first time period (e.g., minute, hour, day, week, month, year, etc.) associated with the networked system.

For example, for MTS data associated with a system of geolocations for a weather prediction model, modeling system 102 may receive time-dependent weather data associated with a region of cities, towns, and/or the like. By way of further example, for MTS data associated with a system of joints for a human body motion-mapping model, modeling system 102 may receive time-dependent (e.g., data variables associated with time steps, stamps, periods, and/or the like) three-dimensional (3D) positioning data associated with connected joints in a human body. By way of further example, for MTS data associated with a computer network of interconnected computing devices for a network activity prediction model, modeling system 102 may receive time-dependent activity data (e.g., number of network messages sent, size of network messages sent, format of network messages sent, etc.) associated with connected computing devices (e.g., servers, personal computers, etc.) in a computer network. By way of further example, for MTS data associated with a road system of interconnected roads for a vehicular traffic prediction model, modeling system 102 may receive time-dependent vehicular traffic data (e.g., number of vehicles, size of vehicles, classification of vehicles, speed of vehicles, and/or the like) associated with a road system of interconnected roads.

In some non-limiting embodiments or aspects, modeling system 102 may mask the plurality of edges of the structural dependency graph (e.g., using a biased random walk process, described further below) to produce a masked structural representation of the structural dependency graph. Modeling system 102 may also mask the MTS data (e.g., using a subsequence patchwise masking process, described further below) to produce a masked temporal representation of the MTS data. Modeling system 102 may further train a spatial-temporal autoencoder based on the masked structural representation and the masked temporal representation to produce a trained spatial-temporal autoencoder.

In some non-limiting embodiments or aspects, modeling system 102 may, when training the spatial-temporal autoencoder, generate a first loss parameter (e.g., a classification loss, described further below) based on a first decoder reconstruction of the structural dependency graph from the masked structural representation, generate a second loss parameter (e.g., a regression loss, described further below) based on a second decoder reconstruction of the MTS data from the masked temporal representation, and minimize a loss function including a combination of the first loss parameter and the second loss parameter. After training the spatial-temporal autoencoder, modeling system 102 may generate a prediction using a spatial-temporal machine learning model including the trained spatial-temporal autoencoder, the prediction associated with an attribute of the networked system in a second time period subsequent to the first time period.

In some non-limiting embodiments or aspects, the networked system may include a system of geolocations (e.g., geographical locations) for a weather prediction model. The plurality of vertices may be associated with locations (e.g., cities, towns, coordinates, zip codes, etc.) and the plurality of edges may be associated adjacent or regionally connected locations (e.g., connected by roads, proximity, geographical features, etc.). In such an example, the prediction may include a forecast of weather (e.g., data associated with temperature, humidity, precipitation, wind, air pollution, air pressure, and/or the like) in the system of geolocations. In response to generating the prediction of a forecast of weather, modeling system 102 may transmit the prediction to computing device 106 of a user (e.g., a user requesting information about a location in the system of geolocations, a user physically present at a location in the system of geolocations, as determined by a location of computing device 106, and/or the like).

In some non-limiting embodiments or aspects, the networked system may be a system of joints (e.g., shoulder, elbow, neck, hip, knee, ankle, wrist, knuckles, etc.) for a human body motion-mapping model. The plurality of vertices may be associated with joints, and the plurality of edges may be associated with body segments (e.g., including lengths of skeleton included in the body rigging) connecting the plurality of joints. In such an example, the prediction may include a classification of a body posture and/or movement (e.g., standing, waving, sitting, running, gesturing, etc.) of human body. In response to generating the prediction of the classification of a body posture and/or movement, modeling system 102 may transmit the prediction to computing device 106 of a user, for use in methods that require an interpretation of a human body's posture and/or movement (e.g., a video game, a motion capture system, an exercise program, etc.).

In some non-limiting embodiments or aspects, the networked system may include a computer network of interconnected computing devices (e.g., server nodes, personal computing devices, routers, etc.) for a network activity prediction model. The plurality of vertices may be associated with a plurality of computing devices, and the plurality of edges may be associated with communicative connections between computing devices of the plurality of computing devices. In such an example, the prediction may include a forecast of network activity in the computer network. In response to generating the prediction of a forecast of network activity in the computer network, modeling system 102 may transmit a notification to computing device 106 of a user based on the prediction, such as to request or automatically trigger mitigating processes for anomalous network activity.

In some non-limiting embodiments or aspects, the networked system may include a road system of interconnected roads for a vehicular traffic prediction model. The plurality of vertices may be associated with a plurality of intersections (e.g., an end of a road, a connection point of one road to another road, etc.), and the plurality of edges may include a plurality of roads. In such an example, the prediction may include a forecast of traffic in the road system. In response to generating the prediction of a forecast of traffic in the road system, modeling system 102 may transmit the prediction (e.g., at least a portion of the traffic forecast) to computing device 106 of a user. By way of further example, computing device 106 and/or user may be traveling on a road (or intending to travel on a road) of the road system when the prediction is transmitted to computing device 106.

In some non-limiting embodiments or aspects, modeling system 102 may be configured to produce various outputs related to spatial-temporal classification and/or prediction, such as for, but not limited to, traffic prediction (e.g., vehicles in streets, connected computing devices in a network, etc.), human action detection (e.g., transactions in an electronic payment processing network, social media activity, user interface navigation and interaction, etc.), trend forecasting (e.g., weather, pandemics, etc.), and/or the like. Modeling system 102 may perform the described methods in self-supervised pretraining and fine-tuning processes. For example, in a pretraining process, modeling system 102 may find self-supervised signals within the data itself to pretrain a spatial-temporal encoder (e.g., also referred to herein as an “autoencoder”). By way of further example, in a fine-tuning process, modeling system 102 may conduct supervised learning on the pretrained encoder and a backbone predictor with ground truth labels. The above-described processes allow for integration of the described methods into any spatial-temporal models, for the purposes of spatial-temporal classification and/or prediction.

With further reference to FIG. 1, modeling system 102 may be configured to perform masked data modeling (MDM), in the form of a spatial-temporal masked autoencoder (STMAE), which is a technically improved method for time-series forecasting across various prediction applications. As described above, STMAE may include two stages. First, a self-supervised pre-training stage may be performed, where modeling system 102 leverages dual decoders on top of the encoders from spatial-temporal models to reconstruct MTS data from both the structural and feature perspectives on masked counterparts. As consecutive steps of MTS may be highly correlated, modeling system 102 may employ biased random walk-based structural masking and patch-based feature masking during pre-training. These masking strategies may enable the learned time-series representations to be more informative, predictive, and consistent on both spatial and temporal dimensions. Second to the pre-training stage is a fine-tuning stage. Modeling system 102 may perform the fine-tuning stage based on the pre-trained encoders and original predictors taken from the spatial-temporal models to predict time-series data accurately. As STMAE may be employed on top of spatial-temporal models with encoder-decoder design, it may be more widely applied compared to contrastive learning (CL)-based methods.

In some non-limiting embodiments or aspects, modeling system 102 may receive MTS data, which may be represented by the following formula:

$$X ∈ {ℝ}^{H \times N \times C} \qquad Formula 1$$

Modeling system 102 may collect the data of the MTS from real-world sensors, which may contain H frames of N time-dependent variables with C features. The time-dependent variables may be represented by the following formula:

$${\{ {x}_{i}^{t} \}}_{i = 1 … N}^{t = 1 … H} \qquad Formula 1$$

Given X, modeling system 102 may be configured to predict F following steps Y, where Y may be represented as the following formula:

$$Y ∈ {ℝ}^{F \times N \times C} \qquad Formula 3$$

All N variables of X may not only be temporally evolving, but they may also often be structurally interrelated. As such, the structural dependency graph G=(V,ε) may be represented as a weighted graph adjacency matrix A. The adjacency matrix A may be represented as the following formula:

$$A ∈ {ℝ}^{N \times N} \qquad Formula 4$$

where each entry Aᵤᵥ denotes the magnitude of the relationship between the variable xᵤ and the variable xᵥ.

In some non-limiting embodiments or aspects, the MTS forecasting problem may be represented as:

$${f}_{θ} ( X , A ) \to Y \qquad Formula 5$$

where f_{θ}(⋅) denotes the parameterized forecaster. In some non-limiting embodiments or aspects, modeling system 102 may rely on a predefined G as part of the model input. Additionally, or alternatively, modeling system 102 may learn the structural dependencies between variables from MTS data, constructing G during learning.

In some non-limiting embodiments or aspects, modeling system 102 may use spatial-temporal models to provide an improved accuracy for MTS forecasting. For example, modeling system 102 may employ an encoder-decoder framework for spatial-temporal modeling. The encoder may be represented as:

$${g}_{w} ( X , A ) \to S \qquad Formula 6$$

Modeling system 102 is configured to summarize, using encoder, complex spatial-temporal patterns from historical MTS data into a hidden representation S, which may be represented as:

$$S ∈ {ℝ}^{N \times D} \qquad Formula 7$$

where D is the hidden dimension and [symbol] is the set of all real numbers.

In some non-limiting embodiments or aspects, modeling system 102 may use recurrent neural networks (RNNs) and convolutional neural networks (CNNs) to learn the temporal correlations across different time steps and use graph neural networks (GNNs) to model the dependencies among variables. After passing X through multiple encoder layers, the temporal dimension may be removed as the temporal patterns are captured in S. Modeling system 102 may be configured to use a predictor to make accurate predictions based on the encoded state S. The predictor may be represented as:

$${r}_{v} ( S ) \to \hat{Y} \qquad Formula 8$$

where Ŷ is a prediction of the model based on the encoded state S, and Y is a ground truth. Compared to the encoder, rᵥ(⋅) may be more lightweight and may take the form of a multilayer perceptron (MLP) with a few layers.

In some non-limiting embodiments or aspects, modeling system 102 may calculate the mean absolute error (MAE) between the predictions of the model Ŷ and the ground truth Y as an objective to train spatial-temporal models. For example, L_{pred} may denote the forecast loss, and the pipeline of spatial-temporal models may be represented as:

$${f}_{θ} ( X , A ) := {r}_{ν} ( {g}_{w} ( X , A ) ) \to \hat{Y} , optimize {ℒ}_{pred} \qquad Formula 9$$

In some non-limiting embodiments or aspects, modeling system 102 may employ, in the overall pipeline of STMAE, a two-stage training scheme: pre-training, and fine-tuning. The pre-training process may include a dual-masking strategy, as further described below. The fine-tuning process may include using the pre-trained encoder to provide context information to enhance the performance of downstream MTS forecasting tasks, also as further described below. As will be appreciated, the encoder g_{w}(⋅) and the predictor rᵥ(⋅) used in the STMAE framework may be taken from spatial-temporal models.

In some non-limiting embodiments or aspects, a goal of the pre-training stage may be to reconstruct the feature X and the structural dependency graph G from their masked counterparts using the encoder g_{w}(⋅). Modeling system 102 may mask both the MTS feature X and the dependency graph G simultaneously (e.g., in a dual-masking process). Each component of the dual-masking process is described in turn, below.

For feature masking, the temporal redundancy of the MTS data allows it to be recovered with little high-level understanding, if the masking areas are sparse. To that end, modeling system 102 may use patch-wise masking. Modeling system 102 may divide the original MTS data into P non-overlapping subsequences of length L, temporally (e.g., supposing H is dividable by P, where H=L×P). Then, modeling system 102 may randomly mask a subset of patches after projecting X to a high-dimensional latent space. The masked patches of X may be replaced by a shared, learnable mask token. Modeling system 102 may select the masking areas uniformly.

For structural masking, the structural redundancy of graphs may make the edge construction task overly simple, as modeling system 102 may only need to pay attention to neighborhoods that are a few hops away from the edges of interest. As more and more spatial-temporal models construct G from the data, it may be highly likely that their Gs have a higher density (even fully connected) compared to the Gs defined by human knowledge. As such, modeling system 102 may mask the edges of G following biased random walks. Specifically, modeling system 102 may first generate paths from G using a biased random walker which may smoothly interpolate between breadth-first sampling (BFS) and depth-first sampling (DFS) of nodes along the path in a flexible manner. Then modeling system 102 may mask all edges belonging to the sampled paths by setting the corresponding entry of A to zero. Compared to uniform masking and plain random walk-based masking, the above-described strategy may flexibly break connections between nodes that either have close proximity or share similar structural roles. This creates a nontrivial problem, which requires modeling system 102 to learn both local and global structural dependencies of G to determine the edges that are masked. For models that learn [symbol] , modeling system 102 may apply the walk-based masking strategy adaptively during learning.

After masking the MTS data and its corresponding structural dependency graph, modeling system 102 may perform the dual reconstruction. For example, X′ and A′ may denote the masked representations of the model inputs. After masking, modeling system 102 may feed X′ and A′ into the encoder g_{w}(⋅) of the spatial-temporal models, obtaining the encoded state S. Rather than using rᵥ(⋅) to predict Y directly, modeling system 102 may reconstruct the original structure and feature attributes of X′ and A′. Specifically, modeling system 102 may use two lightweight decoders to reconstruct the original feature attributes and structure, respectively. For example, p_{ϕ}(⋅) and q_{Ψ}(⋅) may denote the feature decoder and the structure decoder. The encoded state S, therefore, may be represented as follows:

$$S = {g}_{w} ( {X}^{′} , {A}^{′} ) , \hat{X} = {p}_{ϕ} ( S ) , \hat{A} = {q}_{ψ} ( S ) \qquad Formula 10$$

where \hat{X} and Â represent the reconstructed feature and structural dependency graph, respectively.

To perform feature reconstruction and structure reconstruction, modeling system 102 may pursue two objectives, including a regression loss [symbol] _{X} for the MTS feature X and a classification loss [symbol] _{A} for the structure A. Similar to [symbol] _{pred}, [symbol] _{X} computes the MAE between X and the reconstruction \hat{X}. Formally, [symbol] _{X} may be represented as:

$${ℒ}_{X} = {\vert {\hat{X}}_{[ M ]} - {X}_{[ M ]} \vert}_{1} \qquad Formula 11$$

where the subscript [M] denotes the masked area, as modeling system 102 focuses on reconstructing the missing features. On the other hand, [symbol] _{A} aims to reconstruct the masked edges using the standard classification objective. Formally, this may be represented as:

$${ℒ}_{A} = - \frac{1}{\vert {ℰ}_{m a s k} \vert} {\sum }_{( u , v ) ∈ {ℰ}_{m a s k}} log {\hat{A}}_{u ν} \qquad Formula 12$$

where εₘₐₛₖ denotes the masked edge set from G. Modeling system 102 may only compute loss over the masked edges. As such, the overall MDM objective of the pre-training process may be represented as:

$${ℒ}_{pretrain} = {ℒ}_{X} + λ \cdot {ℒ}_{A} \qquad Formula 13$$

where λ is a non-negative hyperparameter trading off the feature loss and the structure loss.

In some non-limiting embodiments or aspects, after modeling system 102 trains the encoder g_{w}(⋅) with the MDM objective, modeling system 102 may fine-tune g_{w}(⋅) with the original untrained predictor rᵥ(⋅) taken from spatial-temporal models to predict Y. Instead of feeding the masked MTS representations to the encoder, modeling system 102 feeds the unmasked X and A to g_{w}(⋅) in the fine-tuning process. In the fine-tuning process, the feature decoder p_{ϕ}(⋅) and the structure decoder q_{Ψ}(⋅) may be discarded. Similarly to the training pipeline described above, the fine-tuning stage of the STMAE framework may aim to optimize [symbol] _{pred}, which may be represented as:

$${ℒ}_{p r e d} = {\vert \hat{Y} - Y \vert}_{1} \qquad Formula 14$$

In some non-limiting embodiments or aspects, the STMAE framework may be a plug-and-play framework for any spatial-temporal models that are tailored to MTS forecasting. Thus, the encoder g_{w}(⋅) and the predictor rᵥ(⋅) may be taken directly from various spatial-temporal baselines. Modeling system 102 may implement the feature decoder p_{ϕ}(⋅) as a single linear layer mapping the hidden state S back to its original dimension C. In the traffic forecasting setting, C=1, and D may be set equal to the latent dimension. The structure decoder q_{Ψ}(⋅), on the other hand, may take the form of an inner product operation, which does not involve learning. This may be represented as:

$${\hat{A}}_{u ν} = \{ \begin{matrix}1 & sigmoid ( {SS}_{uv}^{T} ) \geq 0.5 \\ 0 & otherwise\end{matrix} \qquad Formula 15$$

where the sigmoid(⋅) operation ensures the values fall in the correct range. Modeling system 102 may use the simplest form for the decoder to specifically encourage the encoder g_{w}(⋅) to focus on capturing both the feature and structure information of the MTS X at a high level.

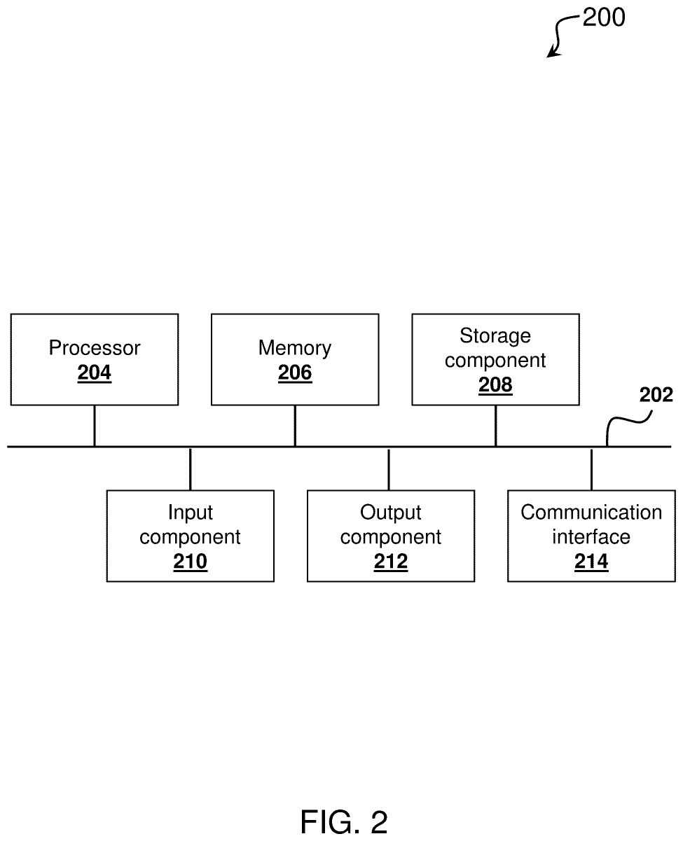

Referring now to FIG. 2, shown is a diagram of example components of a device 200, according to some non-limiting embodiments or aspects. Device 200 may correspond to modeling system 102, memory 104, computing device 106, and/or communication network 108, as an example. In some non-limiting embodiments or aspects, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

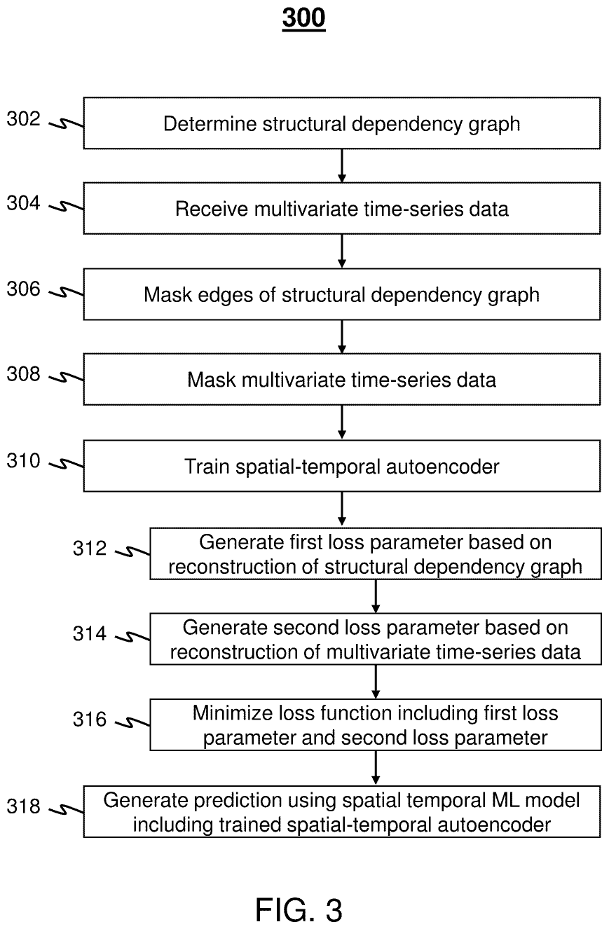

Referring now to FIG. 3, shown is a flow diagram of a method 300 for spatial-temporal prediction using spatial-temporal masked autoencoders, according to some non-limiting embodiments or aspects. The steps shown in FIG. 3 are for example purposes only. It will be appreciated that additional, fewer, different, and/or a different order of steps may be used in non-limiting embodiments or aspects. In some non-limiting embodiments or aspects, a step may be automatically performed in response to performance and/or completion of a prior step. In some non-limiting embodiments or aspects, one or more of the steps of method 300 may be performed (e.g., completely, partially, and/or the like) by modeling system 102. In some non-limiting embodiments or aspects, one or more of the steps of method 300 may be performed (e.g., completely, partially, and/or the like) by another system, another device, another group of systems, or another group of devices, separate from or including modeling system 102.

As shown in FIG. 3, at step 302, method 300 may include determining a structural dependency graph. For example, modeling system 102 may determine a structural dependency graph associated with a networked system. The structural dependency graph may include a plurality of vertices connected by a plurality of edges. In some non-limiting embodiments or aspects, modeling system 102 may receive the structural dependency graph from another networked system and/or device, retrieve the structural dependency graph from memory 104, construct structural dependency graph based on training data of the connected system, and/or the like.

As shown in FIG. 3, at step 304, method 300 may include receiving MTS data. For example, modeling system 102 may receive MTS data from a first time period associated with the networked system. In some non-limiting embodiments or aspects, modeling system 102 may receive MTS data from another networked system and/or device (e.g., a transaction processing system, a network monitoring system, a national weather system, a traffic tracking server, and/or the like, retrieve MTS data from memory 104, generate MTS data based on stored records that are associated with a time-dependent variable, and/or the like.

As shown in FIG. 3, at step 306, method 300 may include masking the edges of the structural dependency graph. For example, modeling system 102 may mask the plurality of edges of the structural dependency graph to produce a masked structural representation of the structural dependency graph. In some non-limiting embodiments or aspects, modeling system 102 may mask the plurality of edges using a biased random walk process (e.g., using techniques as described above).

As shown in FIG. 3, at step 308, method 300 may include masking the MTS data. For example, modeling system 102 may mask the MTS data to produce a masked temporal representation of the MTS data. In some non-limiting embodiments or aspects, modeling system 102 may mask the MTS data using a subsequence patchwise masking process (e.g., using techniques as described above).

As shown in FIG. 3, at step 310, method 300 may include training a spatial-temporal autoencoder. For example, modeling system 102 may train a spatial-temporal autoencoder based on the masked structural representation and the masked temporal representation to produce a trained spatial-temporal autoencoder. Training the spatial-temporal autoencoder may include steps 312, 314, and 316.

As shown in FIG. 3, at step 312, method 300 may include generating a first loss parameter based on a reconstruction of the structural dependency graph. For example, modeling system 102 may generate a first loss parameter based on a first decoder reconstruction of the structural dependency graph from the masked structural representation. In some non-limiting embodiments or aspects, the first loss parameter may include a classification loss based on the first decoder reconstruction of the structural dependency graph from the masked structural representation (e.g., using techniques as described above; see Formula 12).

As shown in FIG. 3, at step 314, method 300 may include generating a second loss parameter based on a reconstruction of the MTS data. For example, modeling system 102 may generate a second loss parameter based on a second decoder reconstruction of the MTS data from the masked temporal representation. In some non-limiting embodiments or aspects, the second loss parameter may include a regression loss based on the second decoder reconstruction of the multivariate time-series data from the masked temporal representation (e.g., using techniques as described above; see Formula 11).

As shown in FIG. 3, at step 316, method 300 may include minimizing a loss function including the first loss parameter and the second loss parameter. For example, modeling system 102 may minimize a loss function including a combination of the first loss parameter and the second loss parameter (e.g., using techniques as described above; see Formulas 13 and 14).

As shown in FIG. 3, at step 318, method 300 may include generating a prediction using a spatial-temporal machine learning (ML) model including the trained spatial-temporal autoencoder. For example, modeling system 102 may generate a prediction (e.g., a time- and space-based output) using a spatial-temporal machine learning model including the trained spatial-temporal autoencoder. The prediction may be associated with an attribute (e.g., a field, a parameter, a value relating to a time and a space) of the network system in a second time period subsequent to the first time period.

In some non-limiting embodiments or aspects, the networked system may include a road system of interconnected roads. The plurality of edges may be associated with a plurality of roads, and the plurality of vertices may be associated with a plurality of intersections. In such an example, the prediction may include a forecast of traffic in the road system. Modeling system 102 may be configured to transmit the prediction to computing device 106 of a user. In some non-limiting embodiments or aspects, computing device 106 and the user may be traveling on a road of the road system when the prediction is transmitted to computing device 106.

In some non-limiting embodiments or aspects, the networked system may include a computer network of interconnected computing devices. The plurality of vertices may be associated with a plurality of computing devices, and the plurality of edges may be associated with communicative connections between computing devices of the plurality of computing devices. In such an example, the prediction may include a forecast of network activity in the computer network, and modeling system 102 may be configured to transmit a notification to computing device 106 of a user based on the prediction (e.g., identifying the forecast, suggesting mitigating action, automatically triggering mitigating action, etc.).

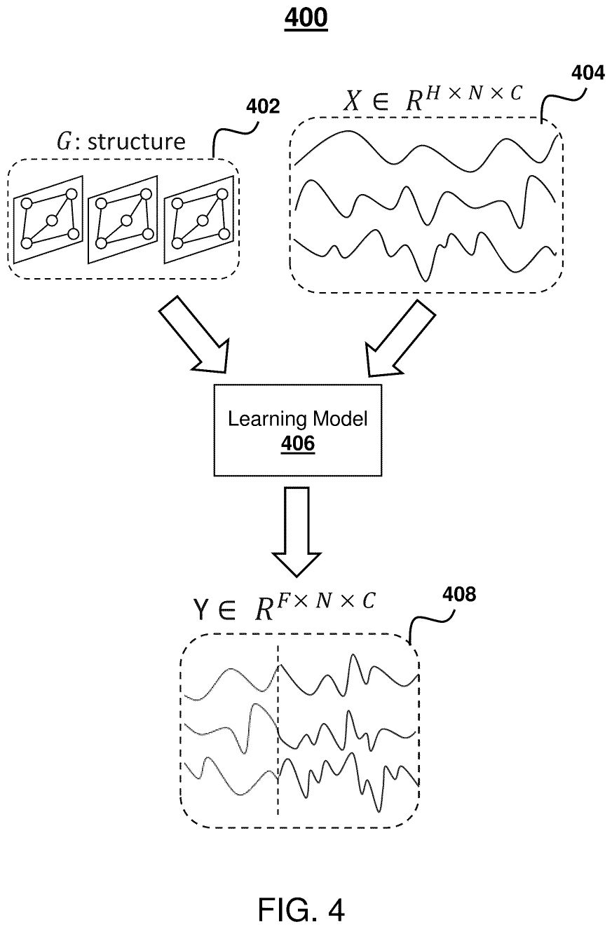

Referring now to FIG. 4, shown is a schematic diagram of a method 400 for spatial-temporal prediction using spatial-temporal masked autoencoders, according to some non-limiting embodiments or aspects. The steps shown in FIG. 4 are for example purposes only. It will be appreciated that additional, fewer, different, and/or a different order of steps may be used in non-limiting embodiments or aspects. In some non-limiting embodiments or aspects, a step may be automatically performed in response to performance and/or completion of a prior step. FIG. 4 illustrates method 400, which represents a high-level process for spatial-temporal forecasting.

As shown in FIG. 4, method 400 may include determining a structural dependency graph (G) 402 associated with a networked system. For example, modeling system 102 may determine structural dependency graph 402. Structural dependency graph 402 may include a plurality of vertices connected by a plurality of edges. In some non-limiting embodiments or aspects, structural dependency graph 402 may or may not have all vertices connected by edges in a single network. In some non-limiting embodiments or aspects, structural dependency graph 402 may include at least one graph associated with at least one time step.

As shown in FIG. 4, method 400 may include receiving MTS data (X) 404 from a first time period (e.g., on the scale of milliseconds, seconds, minutes, hours, days, weeks, months, years, etc.) associated with the networked system. For example, modeling system 102 may receive MTS data 404. The first time period may be subdivided into a plurality of time steps (e.g., milliseconds, seconds, minutes, hours, days, weeks, months, years) therein, of smaller range than the entire time period. MTS data 404 may include records of data (e.g., including one or more variables, parameters, attributes, etc.) associated with each time step (see, e.g., Formula 1, above, and associated discussion).

As shown in FIG. 4, method 400 may include inputting structural dependency graph 402 and MTS data 404 into learning model 406. For example, modeling system 102 may input structural dependency graph 402 and MTS data 404 into learning model 406. Learning model 406 may include one or more machine learning models. As further described herein, learning model 406 may be configured to mask at least a portion of structural dependency graph 402 and MTS data 404, train a spatial-temporal autoencoder based on the masked representations, and generate a prediction using the trained spatial-temporal autoencoder.

As shown in FIG. 4, method 400 may include outputting a prediction 408 from learning model 406. For example, modeling system 102 may output prediction 408 from learning model 406. Prediction 408 may be associated with an attribute of the networked system (e.g., a traffic parameter, a weather parameter, a movement parameter, a posture parameter, etc.) in a second time period subsequent to the first time period (see, e.g., Formula 3, and associated discussion).

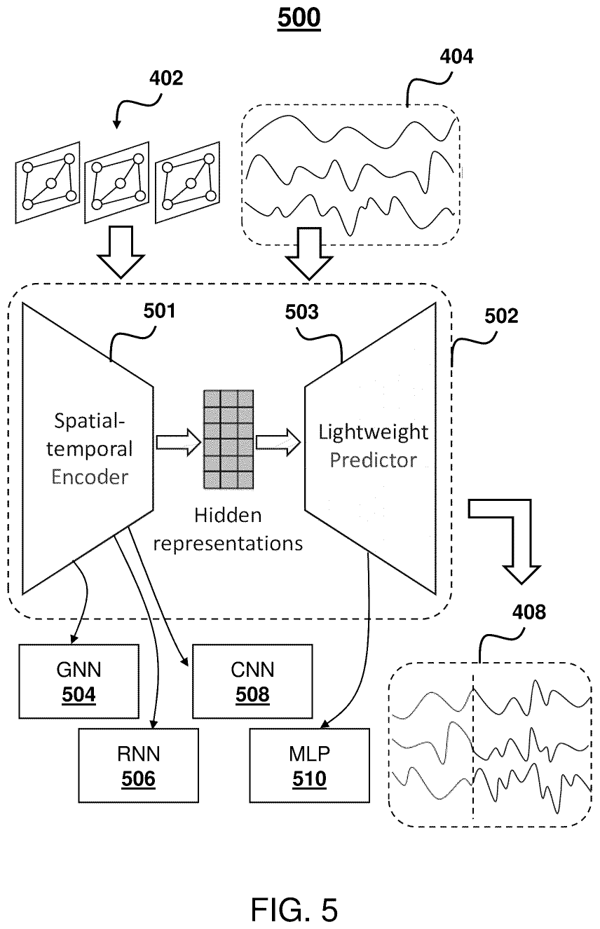

Referring now to FIG. 5, shown is a schematic diagram of a method 500 for spatial-temporal prediction using spatial-temporal masked autoencoders, according to some non-limiting embodiments or aspects. The steps shown in FIG. 5 are for example purposes only. It will be appreciated that additional, fewer, different, and/or a different order of steps may be used in non-limiting embodiments or aspects. FIG. 5 illustrates method 500, which represents a more detailed process flow of method 400 (see FIG. 4).

As shown in FIG. 5, method 500 may include determining a structural dependency graph (G) 402 associated with a networked system. For example, modeling system 102 may determine structural dependency graph 402. Structural dependency graph 402 may include a plurality of vertices connected by a plurality of edges.

As shown in FIG. 5, method 500 may include receiving MTS data (X) 404 from a first time period associated with the networked system. For example, modeling system 102 may receive MTS data 404. The first time period may be subdivided into a plurality of time steps therein, of smaller range than the entire time period. MTS data 404 may include records of data associated with each time step.

As shown in FIG. 5, method 500 may include inputting structural dependency graph 402 and MTS data 404 into learning model 502 (e.g., learning model 406). Learning model 502 includes a spatial-temporal encoder 501 (e.g., a spatial-temporal autoencoder; see also Formula 6) that produces hidden representations (see, e.g., encoded states, described in connection with Formula 7) for use in a lightweight predictor 503 (see, e.g., Formula 8). Modeling system 102 may be configured to use predictor 503 to make accurate predictions based on the hidden representations.

In some non-limiting embodiments or aspects, spatial-temporal encoder 501 may employ one or more machine learning models, such as neural network models, including, but not limited to, a GNN 504, a RNN 506, a CNN 508, and/or the like. In some non-limiting embodiments or aspects, predictor 503 may employ one or more machine learning models, such as MLP 510.

As shown in FIG. 5, method 500 may include outputting prediction 408 from learning model 502. For example, modeling system 102 may output prediction 408 from learning model 502. Prediction 408 may be associated with an attribute of the networked system in a second time period subsequent to the first time period.

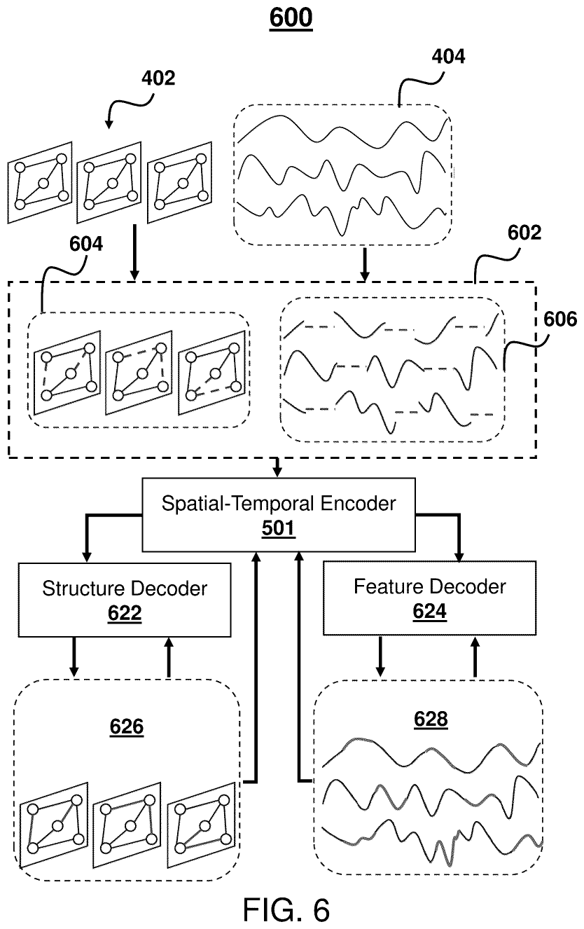

Referring now to FIG. 6, shown is a schematic diagram of a method 600 for spatial-temporal prediction using spatial-temporal masked autoencoders, according to some non-limiting embodiments or aspects. The steps shown in FIG. 6 are for example purposes only. It will be appreciated that additional, fewer, different, and/or a different order of steps may be used in non-limiting embodiments or aspects. In some non-limiting embodiments or aspects, a step may be automatically performed in response to performance and/or completion of a prior step. FIG. 6 illustrates method 600, which includes a pretraining process for a STMAE framework.

As shown in FIG. 6, method 600 may include determining a structural dependency graph (G) 402 associated with a networked system. For example, modeling system 102 may determine structural dependency graph 402. Structural dependency graph 402 may include a plurality of vertices connected by a plurality of edges.

As shown in FIG. 6, method 600 may include receiving MTS data (X) 404 from a first time period associated with the networked system. For example, modeling system 102 may receive MTS data 404. The first time period may be subdivided into a plurality of time steps therein, of smaller range than the entire time period. MTS data 404 may include records of data associated with each time step.

As shown in FIG. 6, method 600 may include performing a masking process 602. For example, modeling system 102 may perform masking process 602. Masking process 602 may include a structural masking process and a feature masking process. In some non-limiting embodiments or aspects, in the structural masking process, modeling system 102 may mask the plurality of edges of structural dependency graph 402 to produce a masked structural representation 604 of structural dependency graph 402. In some non-limiting embodiments or aspects, in the feature masking process, modeling system 102 may mask MTS data 404 to produce a masked temporal representation 606 of MTS data 404.

As shown in FIG. 6, method 600 may include inputting masked representations 604, 606 to spatial-temporal encoder 501. For example, modeling system 102 may input masked structural representation 604 and masked temporal representation 606 to spatial-temporal encoder 501 (see, e.g., Formula 10 and associated discussion). Spatial-temporal encoder 501 may produce encoded state S based on masked structural representation 604 and masked temporal representation 606.

As shown in FIG. 6, method 600 may include inputting at least part of the encoded state S to structure decoder 622 and feature decoder 624. For example, modeling system 102 may input at least part of the encoded state S to structure decoder 622 and feature decoder 624. Structure decoder 622 may perform structure reconstruction 626 based on a classification loss objective for the structural elements (see, e.g., Formula 12 and associated discussion). Feature decoder 624 may perform feature reconstruction 628 based on a regression loss objective for the temporal elements (see, e.g., Formula 11 and associated discussion). In some non-limiting embodiments or aspects, the pretraining process may be looped through spatial-temporal encoder 501, structure decoder 622, feature decoder 624, structure reconstruction 626, and feature reconstruction 628 until each respective loss objective is minimized, so as to train encoder 501 and predictor 503.

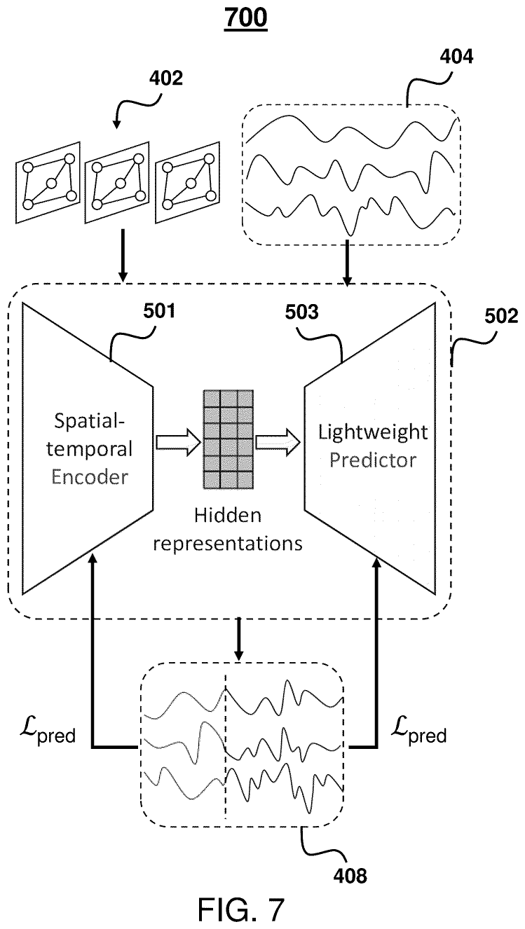

Referring now to FIG. 7, shown is a schematic diagram of a method 700 for spatial-temporal prediction using spatial-temporal masked autoencoders, according to some non-limiting embodiments or aspects. The steps shown in FIG. 7 are for example purposes only. It will be appreciated that additional, fewer, different, and/or a different order of steps may be used in non-limiting embodiments or aspects. In some non-limiting embodiments or aspects, a step may be automatically performed in response to performance and/or completion of a prior step. FIG. 7 illustrates method 700, which represents a fine-tuning stage subsequent to the pre-training stage (see, e.g., FIG. 6).

As shown in FIG. 7, method 700 may include determining a structural dependency graph (G) 402 associated with a networked system. For example, modeling system 102 may determine structural dependency graph 402. Structural dependency graph 402 may include a plurality of vertices connected by a plurality of edges.

As shown in FIG. 7, method 700 may include receiving MTS data (X) 404 from a first time period associated with the networked system. For example, modeling system 102 may receive MTS data 404. The first time period may be subdivided into a plurality of time steps therein, of smaller range than the entire time period. MTS data 404 may include records of data associated with each time step.

As shown in FIG. 7, method 700 may include inputting structural dependency graph 402 and MTS data 404 into learning model 502 (e.g., learning model 406). Learning model 502 includes spatial-temporal encoder 501 that produces hidden representations for use in a lightweight predictor 503. In the fine-tuning process, modeling system may use the pretrained encoder 501 and predictor 502 to generate prediction 408. In some non-limiting embodiments or aspects, structure decoder 622 and feature decoder 624, which were used in the pre-training process, may not be used. Instead, modeling system 102 may optimize a prediction loss ( [symbol] _{pred}) (see, e.g., Formula 14). The fine-tuning process may be looped through encoder 501, predictor 503, and prediction 408 as prediction loss is minimized.

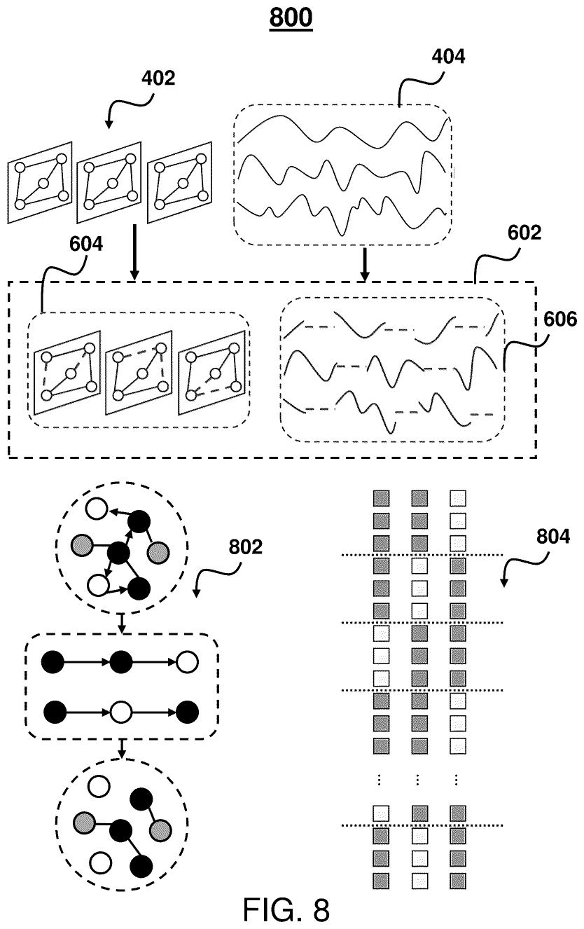

Referring now to FIG. 8, shown is a schematic diagram of a method 800 for spatial-temporal prediction using spatial-temporal masked autoencoders, according to some non-limiting embodiments or aspects. The steps shown in FIG. 8 are for example purposes only. It will be appreciated that additional, fewer, different, and/or a different order of steps may be used in non-limiting embodiments or aspects. In some non-limiting embodiments or aspects, a step may be automatically performed in response to performance and/or completion of a prior step. FIG. 8 illustrates method 800, which includes a detailed schematic diagram of a two-way masking process, for use a STMAE framework (see, e.g., FIG. 6)

As shown in FIG. 8, method 800 may include determining a structural dependency graph (G) 402 associated with a networked system. For example, modeling system 102 may determine structural dependency graph 402. Structural dependency graph 402 may include a plurality of vertices connected by a plurality of edges.

As shown in FIG. 8, method 800 may include receiving MTS data (X) 404 from a first time period associated with the networked system. For example, modeling system 102 may receive MTS data 404. The first time period may be subdivided into a plurality of time steps therein, of smaller range than the entire time period. MTS data 404 may include records of data associated with each time step.

As shown in FIG. 8, method 800 may include performing a masking process 602. For example, modeling system 102 may perform masking process 602. Masking process 602 may include a structural masking process 802 and a feature masking process 804. In some non-limiting embodiments or aspects, in structural masking process 802, modeling system 102 may mask the plurality of edges of structural dependency graph 402 to produce a masked structural representation 604 of structural dependency graph 402. In some non-limiting embodiments or aspects, in feature masking process 804, modeling system 102 may mask MTS data 404 to produce a masked temporal representation 606 of MTS data 404.

In some non-limiting embodiments or aspects, when masking the plurality of edges of structural dependency graph 402 in structural masking process 802, modeling system 102 may be configured to mask the plurality of edges of structural dependency graph using a biased random walk process. In some non-limiting embodiments or aspects, when masking MTS data 404 in feature masking process 804, modeling system 102 may mask MTS data 404 using a subsequence patchwise masking process.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method comprising:
determining, with at least one processor, a structural dependency graph associated with a networked system, the structural dependency graph comprising a plurality of vertices connected by a plurality of edges;
receiving, with at least one processor, multivariate time-series data from a first time period associated with the networked system;
masking, with at least one processor, the plurality of edges of the structural dependency graph to produce a masked structural representation of the structural dependency graph;
masking, with at least one processor, the multivariate time-series data to produce a masked temporal representation of the multivariate time-series data;
training, with at least one processor, a spatial-temporal autoencoder based on the masked structural representation and the masked temporal representation to produce a trained spatial-temporal autoencoder, wherein training the spatial-temporal autoencoder comprises:
generating a first loss parameter based on a first decoder reconstruction of the structural dependency graph from the masked structural representation;
generating a second loss parameter based on a second decoder reconstruction of the multivariate time-series data from the masked temporal representation; and
minimizing a loss function comprising a combination of the first loss parameter and the second loss parameter; and
generating, with at least one processor, a prediction using a spatial-temporal machine learning model comprising the trained spatial-temporal autoencoder, the prediction associated with an attribute of the networked system in a second time period subsequent to the first time period.

2. The method of claim 1, wherein the networked system comprises a road system of interconnected roads, wherein the plurality of edges is associated with a plurality of roads, and wherein the plurality of vertices is associated with a plurality of intersections.

3. The method of claim 2, wherein the prediction comprises a forecast of traffic in the road system, and wherein the method further comprises transmitting, with at least one processor, the prediction to a computing device of a user, the computing device and the user traveling on a road of the road system when the prediction is transmitted to the computing device.

4. The method of claim 1, wherein the networked system comprises a computer network of interconnected computing devices, wherein the plurality of vertices is associated with a plurality of computing devices, and wherein the plurality of edges is associated with communicative connections between computing devices of the plurality of computing devices.

5. The method of claim 4, wherein the prediction comprises a forecast of network activity in the computer network, and wherein the method further comprises transmitting, with at least one processor, a notification to a computing device of a user based on the prediction.

6. The method of claim 1, wherein masking the plurality of edges of the structural dependency graph comprises masking the plurality of edges of the structural dependency graph using a biased random walk process, and wherein masking the multivariate time-series data comprises masking the multivariate time-series data using a subsequence patchwise masking process.

7. The method of claim 1, wherein the first loss parameter comprises a classification loss based on the first decoder reconstruction of the structural dependency graph from the masked structural representation, and wherein the second loss parameter comprises a regression loss based on the second decoder reconstruction of the multivariate time-series data from the masked temporal representation.

8. A system comprising:
at least one processor configured to:
determine a structural dependency graph associated with a networked system, the structural dependency graph comprising a plurality of vertices connected by a plurality of edges;
receive multivariate time-series data from a first time period associated with the networked system;
mask the plurality of edges of the structural dependency graph to produce a masked structural representation of the structural dependency graph;
mask the multivariate time-series data to produce a masked temporal representation of the multivariate time-series data;
train a spatial-temporal autoencoder based on the masked structural representation and the masked temporal representation to produce a trained spatial-temporal autoencoder, wherein, when training the spatial-temporal autoencoder, the at least one processor is configured to:
generate a first loss parameter based on a first decoder reconstruction of the structural dependency graph from the masked structural representation;
generate a second loss parameter based on a second decoder reconstruction of the multivariate time-series data from the masked temporal representation; and
minimize a loss function comprising a combination of the first loss parameter and the second loss parameter; and
generate a prediction using a spatial-temporal machine learning model comprising the trained spatial-temporal autoencoder, the prediction associated with an attribute of the networked system in a second time period subsequent to the first time period.

9. The system of claim 8, wherein the networked system comprises a road system of interconnected roads, wherein the plurality of edges is associated with a plurality of roads, and wherein the plurality of vertices is associated with a plurality of intersections.

10. The system of claim 9, wherein the prediction comprises a forecast of traffic in the road system, and wherein the at least one processor is further configured to transmit the prediction to a computing device of a user, the computing device and the user traveling on a road of the road system when the prediction is transmitted to the computing device.

11. The system of claim 8, wherein the networked system comprises a computer network of interconnected computing devices, wherein the plurality of vertices is associated with a plurality of computing devices, and wherein the plurality of edges is associated with communicative connections between computing devices of the plurality of computing devices.

12. The system of claim 11, wherein the prediction comprises a forecast of network activity in the computer network, and wherein the at least one processor is further configured to transmit a notification to a computing device of a user based on the prediction.

13. The system of claim 8, wherein, when masking the plurality of edges of the structural dependency graph, the at least one processor is configured to mask the plurality of edges of the structural dependency graph using a biased random walk process, and wherein, when masking the multivariate time-series data, the at least one processor is configured to mask the multivariate time-series data using a subsequence patchwise masking process.

14. The system of claim 8, wherein the first loss parameter comprises a classification loss based on the first decoder reconstruction of the structural dependency graph from the masked structural representation, and wherein the second loss parameter comprises a regression loss based on the second decoder reconstruction of the multivariate time-series data from the masked temporal representation.

15. A computer program product comprising at least one non-transitory computer-readable medium including program instructions that, when executed by at least one processor, cause the at least one processor to:
determine a structural dependency graph associated with a networked system, the structural dependency graph comprising a plurality of vertices connected by a plurality of edges;
receive multivariate time-series data from a first time period associated with the networked system;
mask the plurality of edges of the structural dependency graph to produce a masked structural representation of the structural dependency graph;
mask the multivariate time-series data to produce a masked temporal representation of the multivariate time-series data;
train a spatial-temporal autoencoder based on the masked structural representation and the masked temporal representation to produce a trained spatial-temporal autoencoder, wherein the program instructions that cause the at least one processor to train the spatial-temporal autoencoder cause the at least one processor to:
generate a first loss parameter based on a first decoder reconstruction of the structural dependency graph from the masked structural representation;
generate a second loss parameter based on a second decoder reconstruction of the multivariate time-series data from the masked temporal representation; and
minimize a loss function comprising a combination of the first loss parameter and the second loss parameter; and
generate a prediction using a spatial-temporal machine learning model comprising the trained spatial-temporal autoencoder, the prediction associated with an attribute of the networked system in a second time period subsequent to the first time period.

16. The computer program product of claim 15, wherein the networked system comprises a road system of interconnected roads, wherein the plurality of edges is associated with a plurality of roads, and wherein the plurality of vertices is associated with a plurality of intersections.

17. The computer program product of claim 16, wherein the prediction comprises a forecast of traffic in the road system, and wherein the program instructions further cause the at least one processor to transmit the prediction to a computing device of a user, the computing device and the user traveling on a road of the road system when the prediction is transmitted to the computing device.

18. The computer program product of claim 15, wherein the networked system comprises a computer network of interconnected computing devices, wherein the plurality of vertices is associated with a plurality of computing devices, wherein the plurality of edges is associated with communicative connections between computing devices of the plurality of computing devices, wherein the prediction comprises a forecast of network activity in the computer network, and wherein the program instructions further cause the at least one processor to transmit a notification to a computing device of a user based on the prediction.

19. The computer program product of claim 15, wherein the program instructions that cause the at least one processor to mask the plurality of edges of the structural dependency graph cause the at least one processor to mask the plurality of edges of the structural dependency graph using a biased random walk process, and wherein the program instructions that cause the at least one processor to mask the multivariate time-series data cause the at least one processor to mask the multivariate time-series data using a subsequence patchwise masking process.

20. The computer program product of claim 15, wherein the first loss parameter comprises a classification loss based on the first decoder reconstruction of the structural dependency graph from the masked structural representation, and wherein the second loss parameter comprises a regression loss based on the second decoder reconstruction of the multivariate time-series data from the masked temporal representation.
